(19) United States
(12) Patent Application Publication
(10) Pub. No.: US 2024/0116774 A1
(43) Pub. Date: Apr. 11, 2024

(54) TUNGSTEN PRECURSORS AND RELATED METHODS

(71) Applicant: ENTEGRIS, INC., Billerica, MA (US)

(72) Inventors: Loren Press, Burnet, TX (US); Benjamin Garrett, Leander, TX (US); Michael Watson, Leander, TX (US); Scott L. Battle, Cedar Park, TX (US); Thomas M. Cameron, Newtown, CT (US); Bryan Hendrix, Danbury, CT (US)

(21) Appl. No.: 18/376,476

(22) Filed: Oct. 4, 2023

Related U.S. Application Data
(60) Provisional application No. 63/413,510, filed on Oct. 5, 2022.

(51) Int. Cl. C01G 41/04

(52) U.S. Cl. CPC C01G 41/04

(57) ABSTRACT

A precursor comprises a tungsten precursor and a carbon-containing material. The precursor comprises less than 0.02% by weight of the carbon-containing material based on a total weight of the precursor. A method for purifying a tungsten precursor may comprise at least one of the following steps: obtaining a source vessel containing a tungsten precursor and a carbon-containing material; separating the tungsten precursor from at least a first portion of the carbon-containing material; recovering a precursor in a collection vessel; or any combination thereof.

### FIELD

The present disclosure relates to the field of tungsten precursors and related methods, including, for example and without limitation, methods for purifying and methods for validating impurity levels.

### BACKGROUND

The presence of impurities in precursors used for semiconductor fabrication results in defects and undesired variability. Current analytical techniques for measuring impurity level are not capable of detecting or validating sufficiently low impurity levels.

### SUMMARY

Some embodiments of the present disclosure relate to a precursor. In some embodiments, the precursor comprises a tungsten precursor. In some embodiments, the precursor comprises a carbon-containing material. In some embodiments, the precursor comprises less than 0.02% by weight of the carbon-containing material based on a total weight of the precursor, as measured by Total Carbon analysis using Non-Dispersive Infrared Detection.

Some embodiments relate to a method for purifying a tungsten precursor. In some embodiments, the method comprises obtaining a source vessel containing a tungsten precursor and a carbon-containing material. In some embodiments, the method comprises separating the tungsten precursor from at least a first portion of the carbon-containing material. In some embodiments, separating the tungsten precursor from at least a first portion of the carbon-containing material comprises applying a first condition to the source vessel, so as to produce a tungsten precursor vapor comprising at least one of a first carbon-containing vapor, a first plurality of carbon-containing particles, or any combination thereof; removing the first portion of the carbon-containing material from the tungsten precursor vapor by at least one of flowing the tungsten precursor vapor through a filter, so as to remove at least a portion of the first plurality of carbon-containing particles, flowing the tungsten precursor vapor over a sorbent, so as to remove at least a portion of the first carbon-containing vapor, or any combination thereof. In some embodiments, the method comprises flowing the tungsten precursor vapor to a collection vessel. In some embodiments, the method comprises separating the tungsten precursor from at least a second portion of the carbon-containing material by at least one of applying a second condition to the collection vessel, so as to produce a tungsten precursor condensate and a second carbon-containing vapor, removing at least a portion of the second carbon-containing vapor from the collection vessel, or any combination thereof. In some embodiments, the method comprises recovering a precursor in a collection vessel. In some embodiments, the method comprises validating a low carbon content of the precursor present in the collection vessel.

Some embodiments relate to a method for validating a low impurity content. In some embodiments, the method comprises obtaining a collection vessel containing a precursor. In some embodiments, the precursor comprises a tungsten precursor. In some embodiments, the precursor comprises a carbon-containing material. In some embodiments, the method comprises removing a sample of the precursor from the collection vessel. In some embodiments, the method comprises measuring a carbon content of the precursor, so as to validate or not validate the low carbon content of the precursor. In some embodiments, the method comprises, when the low carbon content of the precursor is not validated, removing at least a portion of the carbon-containing material from the precursor.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a flowchart of a method for purifying a tungsten precursor, according to some embodiments.

FIG. 2 is a flowchart of a method for separating a carbon-containing material from a tungsten precursor, according to some embodiments.

FIG. 3 is a flowchart of a method for separating a carbon-containing material from a tungsten precursor, according to some embodiments.

FIG. 4 is a flowchart of a method for separating a carbon-containing material from a tungsten precursor, according to some embodiments.

FIG. 5 is a flowchart of a method for separating a carbon-containing material from a tungsten precursor, according to some embodiments.

FIG. 6 is a flowchart of a method for validating a carbon content of a tungsten precursor, according to some embodiments.

FIG. 7 is a schematic diagram of a system for removing a carbon-containing material from a precursor, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may.

Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Some embodiments relate to a precursor. The precursor may comprise a tungsten precursor and at least one impurity. In some embodiments, the tungsten precursor comprises tungsten pentachloride (WCl₅). In some embodiments, the tungsten precursor comprises tungsten hexachloride (WCl₆). In some embodiments, the tungsten precursor comprises one of WCl₅ or WCl₆. In some embodiments, the at least one impurity comprises a carbon material. In some embodiments, the carbon-containing material comprises at least one of a volatile compound (e.g., a volatile carbon-containing material), a non-volatile compound (e.g., a non-volatile carbon-containing material), or any combination thereof. In some embodiments, the at least one impurity comprises a chlorinated hydrocarbon. In some embodiments, the carbon-containing material comprises at least one of hydrocarbon polymers, haloalkanes, haloalkenes, halocycloalkanes, halo-substituted arenes, or any combination thereof. In some embodiments, the carbon-containing material comprises a substituent (e.g., a functional group(s)). In some embodiments, the carbon-containing material comprises a volatile carbon species that is volatile at conditions of vaporizing the tungsten precursor. In some embodiments, the carbon-containing material comprises entrained particular carbon species (e.g., species to be captured by a filter). In some embodiments, the at least one impurity comprises at least one of dichloromethane, phosgene, 1,1-dichloroethane, chloroform, 1,2-dichloroethane, carbon tetrachloride, tetrachloroethylene, trichlorethylene, 1,3-dichloropropane, 1,2,3-trichloropropane, 1,2-dichloropropane, 1,1,2-trichloroethane, 1,1,2-trichloropropane, 1,2,2-trichloropropane, 1,1,2,3-tetrachloropropane, 1,2,2,3-tetrachloropropane, 1,1,2,2,-tetrachloroethane, 2,2-dichloropropanoyl chloride, 1,3-dichloro-1-propene, 3,3,3-trichloro-1-propene, 1,2,3-trichloro-1-propene, 1,3-dichloro-2-methylenepropane, 1,4-dichlorobutane, 1,3-dichloro-2-butene, 1,1,3,3-tetrachloro-2-methylpropane, 1,1,2,3,3-pentachloropropane, 1,3-dichlorocyclopentane, 1,1,2,2,3,3-hexachloropropane, 1,2,3,4,5,5-hexanechloro-1,3-cyclopentadiene, trichlorocyclopentene, tetrachlorocyclopentene, pentachloronorbornene, or any combination thereof.

The precursor may comprise less than 0.05% by weight of the carbon material based on a total weight of the precursor, or any range or subrange therebetween. In some embodiments, the precursor comprises less than 0.02%, less than 0.019%, less than 0018%, less than 0017%, less than 0016%, less than 0.015%, less than 0.014%, less than 0.013%, less than 0.012%, less than 0.011%, less than 0.010%, less than 0.009%, less than 0.008%, less than 0.007%, less than 0.006%, less than 0.005%, less than 0.004%, less than 0.003%, less than 0.002%, less than 0.001%, less than 0.0009%, less than 0.0008%, less than 0.0007%, less than 0.0006%, less than 0.0005%, less than 0.0004%, less than 0.0003%, less than 0.0002%, or less than 0.0001% by weight of the carbon material based on the total weight of the precursor as measured by Total Carbon analysis using Non-Dispersive Infrared Detection.

The precursor may comprise 0.0001% to 0.05% by weight of the carbon material based on the total weight of the precursor, or any range or subrange therebetween.

In some embodiments, the precursor comprises 0.0001% to 0.02%, 0.0001% to 0.019%, 0.0001% to 0.018%, 0.0001% to 0.017%, 0.0001% to 0.016%, 0.0001% to 0.015%, 0.0001% to 0.014%, 0.0001% to 0.013%, 0.0001% to 0.012%, 0.0001% to 0.011%, 0.0001% to 0.010%, 0.0001% to 0.009%, 0.0001% to 0.008%, 0.0001% to 0.007%, 0.0001% to 0.006%, 0.0001% to 0.005%, 0.0001% to 0.004%, 0.0001% to 0.003%, 0.0001% to 0.002%, 0.0001% to 0.001%, 0.0002% to 0.015%, 0.0003% to 0.015%, 0.0004% to 0.015%, 0.0005% to 0.015%, 0.0006% to 0.015%, 0.0007% to 0.015%, 0.0008% to 0.015%, 0.0009% to 0.015%, 0.001% to 0.015%, 0.0011% to 0.015%, 0.0012% to 0.015%, 0.0013% to 0.015%, 0.0014% to 0.015%, 0.0002% to 0.001%, 0.0003% to 0.001%, 0.0004% to 0.001%, 0.0005% to 0.001%, 0.0006% to 0.001%, 0.0007% to 0.001%, 0.0008% to 0.001%, 0.0009% to 0.001%, 0.0002% to 0.0009%, 0.0002% to 0.0008%, 0.0002% to 0.0007%, 0.0002% to 0.0006%, 0.0002% to 0.0005%, 0.0002% to 0.0004%, 0.0002% to 0.0003%, 0.005% to 0.015%, 0.006% to 0.015%, 0.007% to 0.015%, 0.008% to 0.015%, 0.009% to 0.015%, 0.01% to 0.015%, 0.01% to 0.015%, 0.012% to 0.015%, 0.013% to 0.015%, 0.014% to 0.015%, 0.006% to 0.014%, 0.006% to 0.013%, 0.006% to 0.012%, 0.006% to 0.011%, 0.006% to 0.01%, 0.006% to 0.009%, 0.006% to 0.008%, or 0.006% to 0.007% as measured by Total Carbon analysis using Non-Dispersive Infrared Detection.

Some embodiments relate to a method for purifying a tungsten precursor. Various embodiments of the method for purifying the tungsten precursor are provided herein. It will be appreciated that any combination of steps, in any order, may be performed in the method for purifying the tungsten precursor, without departing from the scope of this disclosure. Accordingly, that various methods and the steps of those methods are depicted in different figures shall not be limiting, as any combination of steps in any of the figures disclosed herein, in any combination, may be performed, without departing from the scope of this disclosure.

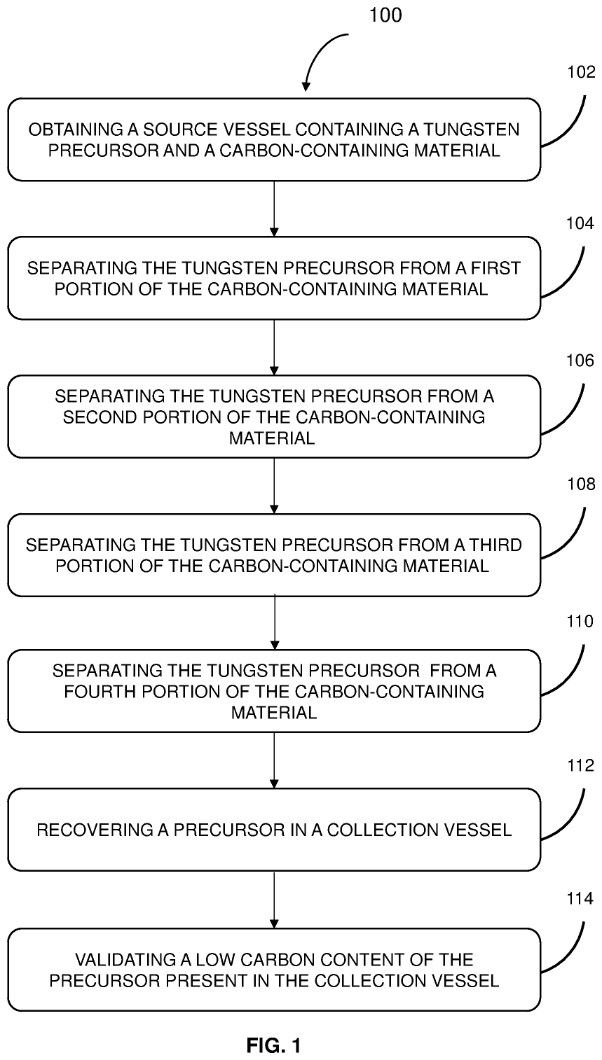

FIG. 1 is a flowchart of a method 100 for purifying a tungsten precursor, according to some embodiments. As shown in FIG. 1, the method 100 for purifying a tungsten precursor may comprise at least one of the following steps: a step 102 of obtaining a source vessel containing a tungsten precursor and a carbon-containing material; a step 104 of separating the tungsten precursor from at least a first portion of the carbon-containing material; a step 106 of separating the tungsten precursor from at least a second portion of the carbon-containing material; a step 108 of separating the tungsten precursor from a third portion of the carbon-containing material; a step 110 of separating the tungsten precursor from a fourth portion of the carbon-containing material; a step 112 of recovering a precursor in a collection vessel; a step 114 of validating a low carbon content of the precursor present in the collection vessel; or any combination thereof.

At step 102, in some embodiments, the source vessel containing the tungsten precursor and the carbon-containing material is obtained. The tungsten precursor may be present in the source vessel in the form of at least one of at least one of a solid, a gas/vapor, or any combination thereof. For example, in some embodiments, the tungsten precursor is present as a solid and as a vapor. In some embodiments, the solid phase of the tungsten precursor is amorphous or crystalline. In some embodiments, the tungsten precursor is present as an isolated crystal. The carbon-containing material may be present in the source vessel in the form of at least one of a solid, a liquid, a gas/vapor, or any combination thereof. In some embodiments, the carbon-containing material comprises at least one of a carbon-containing vapor, a plurality of carbon-containing particles, or any combination thereof. In some embodiments, the carbon-containing material comprises a volatile carbon material. In some embodiments, the carbon-containing material comprises a chlorinated hydrocarbon. In some embodiments, the carbon-containing material comprises at least one of dichloromethane, phosgene, 1,1-dichloroethane, chloroform, 1,2-dichloroethane, carbon tetrachloride, tetrachloroethylene, trichlorethylene, 1,3-dichloropropane, 1,2,3-trichloropropane, 1,2-dichloropropane, 1,1,2-trichloroethane, 1,1,2-trichloropropane, 1,2,2-trichloropropane, 1,1,2,3-tetrachloropropane, 1,2,2,3-tetrachloropropane, 1,1,2,2,-tetrachloroethane, 2,2-dichloropropanoyl chloride, 1,3-dichloro-1-propene, 3,3,3-trichloro-1-propene, 1,2,3-trichloro-1-propene, 1,3-dichloro-2-methylenepropane, 1,4-dichlorobutane, 1,3-dichloro-2-butene, 1,1,3,3-tetrachloro-2-methylpropane, 1,1,2,3,3-pentachloropropane, 1,3-dichlorocyclopentane, 1,1,2,2,3,3-hexachloropropane, 1,2,3,4,5,5-hexanechloro-1,3-cyclopentadiene, trichlorocyclopentene, tetrachlorocyclopentene, pentachloronorbornene, or any combination thereof. In some embodiments, the carbon-containing material is present as a solid and as a vapor. In some embodiments, the solid phase of the carbon-containing material is amorphous or crystalline. In some embodiments, the carbon-containing material is present in the source vessel as an isolated crystal. In some embodiments, the carbon-containing material is present within the crystal lattice of the tungsten precursor. For example, in some embodiments, the carbon-containing material is dissolved in the crystal lattice of the tungsten precursor.

The source vessel may be configured to control temperature. The temperature of the source vessel may be controlled in any suitable manner. In some embodiments, a thermal jacket for heating and/or cooling is employed around the source vessel. In some embodiments, a ribbon heater is wound around the source vessel. In some embodiments, a block heater having a shape covering at least a major portion of the external surface of the source vessel is employed to heat the source vessel. In some embodiments, a resistive heater is employed to heat the source vessel. In some embodiments, a lamp heater is employed to heat the source vessel. In some embodiments, a heat transfer fluid at elevated temperature may be contacted with the exterior surface of the source vessel, to effect heating and/or cooling thereof. In some embodiments, the heating is conducted by infrared or other radiant energy being impinged on the source vessel. In some embodiments, the collection vessel is cooled by a fluid, a fan, a direct thermoelectric device, or any combination thereof. It is to be appreciated that other heating and/or cooling devices and assemblies, and other configurations and arrangements of the heater and/or cooler may be employed herein without departing from the scope of this disclosure.

The source vessel may be configured to control pressure. The pressure of the source vessel may be controlled in any suitable manner. In some embodiments, a gas inlet line is fluidly coupled to the source vessel. The gas inlet line may be configured to supply a pressurizing gas from a pressurizing gas source to the source vessel. Control of the pressurizing gas into the source vessel may be achieved by at least one of pressure regulators, needle valves, mass flow controllers, downstream pressure controllers, or any combination thereof. In some embodiments, the pressurizing gas comprises an inert gas. In some embodiments, the inert gas comprises at least one of helium, argon, nitrogen, or any combination thereof. In some embodiments, a vacuum line is fluidly coupled to the source vessel. The vacuum line may be configured to apply a vacuum to the source vessel. In some embodiments, the pumping speed is controlled by butterfly valves. It will be appreciated that other mechanisms for controlling the pressure of the source vessel may be employed herein without departing from the scope of this disclosure.

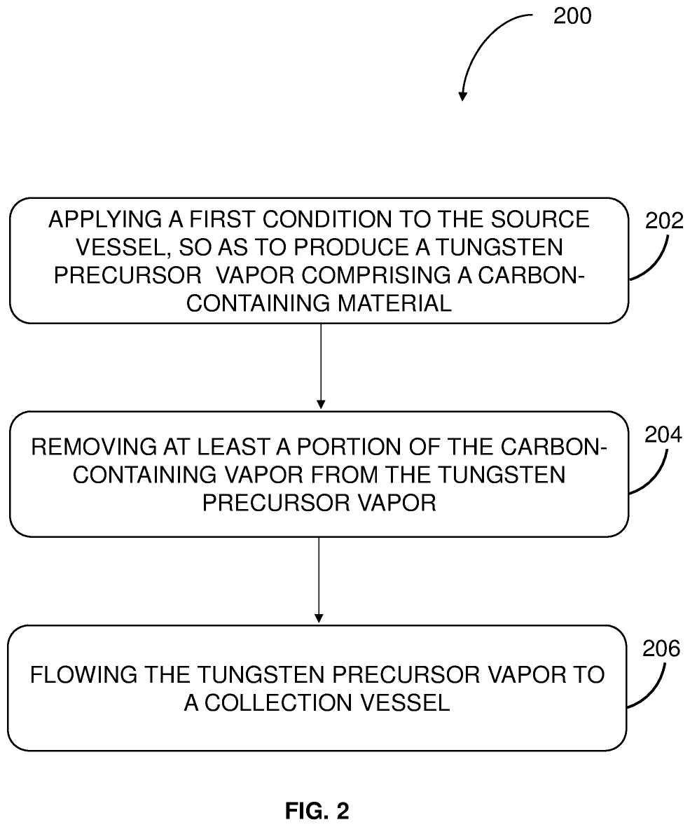

At step 104, the tungsten precursor is separated from at least a first portion of the carbon-containing material. As disclosed herein (e.g., in FIG. 2), in some embodiments, the tungsten precursor may be separated from the first portion of the carbon-containing material by applying a first condition (e.g., at least one of a temperature, a pressure, an inert gas flow, a vacuum, or any combination thereof) to the source vessel, so as to produce a tungsten precursor vapor comprising the carbon-containing material. In some embodiments, the carbon-containing material comprises at least one of a first carbon-containing vapor, a first plurality of carbon-containing particles, or any combination thereof. In some embodiments, the first condition is a condition under which a total pressure of the source vessel is below a true vapor pressure of the tungsten precursor for a given first temperature. In some embodiments, the first condition is a condition under which a total pressure of the source vessel is below a true vapor pressure of the carbon-containing material for a given first temperature. In some embodiments, the tungsten precursor may be separated from the first portion of the carbon-containing material by removing the first portion of the carbon-containing material from the tungsten precursor vapor. In some embodiments, the removing step comprises flowing the tungsten precursor vapor through a filter, so as to remove at least a portion of the first plurality of carbon-containing particles. In some embodiments, the removing step comprises flowing the tungsten precursor vapor over a sorbent, so as to remove at least a portion of the first carbon-containing vapor. In some embodiments, the tungsten precursor may be separated from the first portion of the carbon-containing material by flowing the tungsten precursor vapor to a collection vessel.

The filter may comprise a filter or filtration media suitable for removing the carbon-containing particles from the tungsten precursor vapor. In some embodiments, the filter comprises at least one of the following: at least one of a wool, a glass wool (e.g., a glass wool made of at least one of quartz, glass, or borosilicate), a sintered metal, a fritted glass, a sintered glass, a resin, a porous polymer, a ceramic, a cyclonic material, an electrostatic material, a fibrous metal filter, or any combination thereof. In some embodiments, the filter comprises at least one of a perfluoroalkoxy alkane (PFA), a polytetrafluoroethylene (PTFE), a polypropylene, a polyethylene, a fibrous polymer, any copolymer thereof, or any combination thereof.

The sorbent may comprise a material suitable for removing the carbon-containing vapor from the tungsten precursor vapor. In some embodiments, the sorbent comprises an absorbent. In some embodiments, the sorbent comprises an adsorbent. In some embodiments, the sorbent comprises at least one of activated carbon, alumina, aluminosilicates, zeolites, silicas, polymers, metal organic frameworks, alkali oxides, metal oxides, graphite felt, or any combination thereof.

The collection vessel may be configured to control temperature. The temperature of the collection vessel may be controlled in any suitable manner. In some embodiments, a thermal jacket for heating and/or cooling is employed around the collection vessel. In some embodiments, a ribbon heater is wound around the collection vessel. In some embodiments, a block heater having a shape covering at least a major portion of the external surface of the collection vessel is employed to heat the collection vessel. In some embodiments, a resistive heater is employed to heat the collection vessel. In some embodiments, a lamp heater is employed to heat the collection vessel. In some embodiments, a heat transfer fluid at elevated temperature may be contacted with the exterior surface of the collection vessel, to effect heating and/or cooling thereof. In some embodiments, the heating is conducted by infrared or other radiant energy being impinged on the collection vessel. In some embodiments, the collection vessel is cooled by a fluid, a fan, a direct thermoelectric device, or any combination thereof. It is to be appreciated that other heating and/or cooling devices and assemblies, and other configurations and arrangements of the heater and/or cooler may be employed herein without departing from the scope of this disclosure.

The collection vessel may be configured to control pressure. The pressure of the collection vessel may be controlled in any suitable manner. In some embodiments, a gas inlet line is fluidly coupled to the collection vessel. The gas inlet line may be configured to supply a pressurizing gas from a pressurizing gas source to the collection vessel. Control of the pressurizing gas into the collection vessel may be achieved by at least one of pressure regulators, needle valves, mass flow controllers, downstream pressure controllers, or any combination thereof. In some embodiments, the pressurizing gas comprises an inert gas. In some embodiments, the inert gas comprises at least one of helium, argon, nitrogen, or any combination thereof. In some embodiments, a vacuum line is fluidly coupled to the collection vessel. The vacuum line may be configured to apply a vacuum to the collection vessel. In some embodiments, the pumping speed is controlled by butterfly valves. It will be appreciated that other mechanisms for controlling the pressure of the source vessel may be employed herein without departing from the scope of this disclosure.

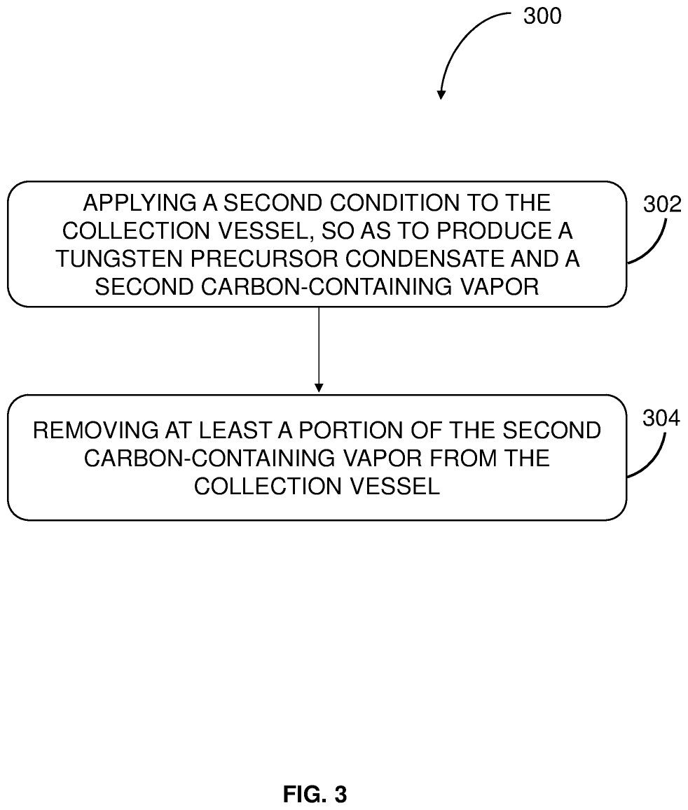

At step 106, the tungsten precursor is separated from at least a second portion of the carbon-containing material. As disclosed herein (e.g., in FIG. 3), in some embodiments, the tungsten precursor may be separated from at least a second portion of the carbon-containing material by applying a second condition (e.g., at least one of a temperature, a pressure, an inert gas flow, a vacuum, or any combination thereof) to the collection vessel, so as to produce a tungsten precursor condensate and a second carbon-containing vapor. In some embodiments, the tungsten precursor may be separated from at least a second portion of the carbon-containing material by removing at least a portion of the second carbon-containing vapor from the collection vessel. In some embodiments, the second condition is a condition under which a greater volume of the tungsten precursor condenses than the second carbon-containing vapor. In some embodiments, when applying the second condition, the tungsten precursor condensate comprises a greater mole fraction of the tungsten precursor than the carbon-containing material.

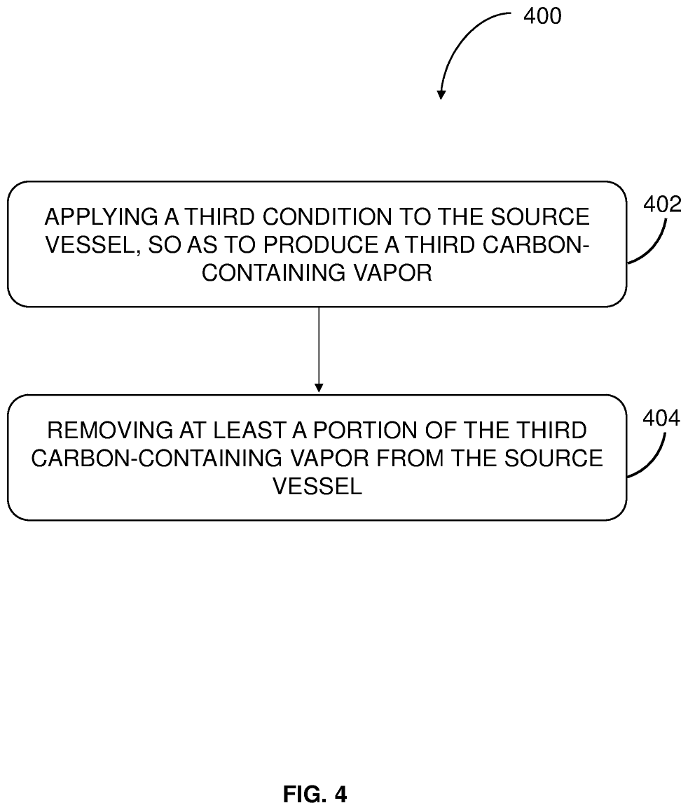

At step 108, in some embodiments, the tungsten precursor is separated from a third portion of the carbon-containing material. As disclosed herein (e.g., in FIG. 4), in some embodiments, the tungsten precursor may be separated from a third portion of the carbon-containing material by applying a third condition (e.g., at least one of a temperature, a pressure, an inert gas flow, a vacuum, or any combination thereof) to the source vessel, so as to produce a third carbon-containing vapor. In some embodiments, the tungsten precursor may be separated from a third portion of the carbon-containing material by removing at least a portion of the third carbon-containing vapor from the source vessel. In some embodiments, the step 108 is performed prior to the step 104. In some embodiments, the third condition is a condition under which a total pressure of the source vessel is below a true vapor pressure of the carbon-containing material for a given third temperature. In some embodiments, the third condition is a condition under which a total pressure of the source vessel is above a true vapor pressure of the tungsten precursor for a given third temperature. In some embodiments, when applying the third condition, the third carbon-containing vapor comprises a greater volume of the carbon-containing material than the tungsten precursor.

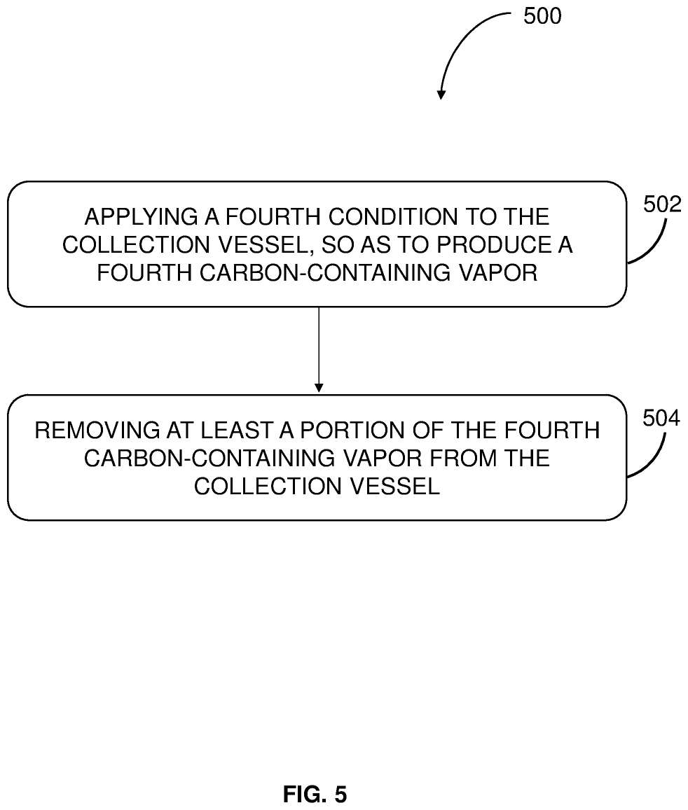

At step 110, in some embodiments, the tungsten precursor is separated from a fourth portion of the carbon-containing material. As disclosed herein, (e.g., in FIG. 5), in some embodiments, the tungsten precursor may be separated from a fourth portion of the carbon-containing material by applying a fourth condition (e.g., at least one of a temperature, a pressure, an inert gas flow, a vacuum, or any combination thereof) to the collection vessel, so as to produce a fourth carbon-containing vapor. In some embodiments, the tungsten precursor may be separated from a fourth portion of the carbon-containing material by removing at least a portion of the fourth carbon-containing vapor from the collection vessel. In some embodiments, the step 110 is performed after the step 114 discussed below. In some embodiments, the fourth condition is a condition under which a total pressure of the collection vessel is below a true vapor pressure of the carbon-containing material for a given fourth temperature. In some embodiments, the fourth condition is a condition under which a total pressure of the collection vessel is above a true vapor pressure of the tungsten precursor for a given fourth temperature. In some embodiments, when applying the fourth condition, the fourth carbon-containing vapor comprises a greater volume of the carbon-containing material than the tungsten precursor.

At step 112, in some embodiments, the precursor is recovered in the collection vessel. In some embodiments, the precursor comprises the tungsten precursor and the carbon-containing material. In some embodiments, the precursor comprises less than 0.02% by weight of the carbon-containing material based on a total weight of the precursor, as measured by Total Carbon analysis using Non-Dispersive Infrared Detection. In some embodiments, the carbon-containing material comprises a chlorinated hydrocarbon. In some embodiments, the carbon-containing material comprises at least one of dichloromethane, phosgene, 1,1-dichloroethane, chloroform, 1,2-dichloroethane, carbon tetrachloride, tetrachloroethylene, trichlorethylene, 1,3-dichloropropane, 1,2,3-trichloropropane, 1,2-dichloropropane, 1,1,2-trichloroethane, 1,1,2-trichloropropane, 1,2,2-trichloropropane, 1,1,2,3-tetrachloropropane, 1,2,2,3-tetrachloropropane, 1,1,2,2,-tetrachloroethane, 2,2-dichloropropanoyl chloride, 1,3-dichloro-1-propene, 3,3,3-trichloro-1-propene, 1,2,3-trichloro-1-propene, 1,3-dichloro-2-methylenepropane, 1,4-dichlorobutane, 1,3-dichloro-2-butene, 1,1,3,3-tetrachloro-2-methylpropane, 1,1,2,3,3-pentachloropropane, 1,3-dichlorocyclopentane, 1,1,2,2,3,3-hexachloropropane, 1,2,3,4,5,5-hexanechloro-1,3-cyclopentadiene, trichlorocyclopentene, tetrachlorocyclopentene, pentachloronorbornene, or any combination thereof, or any combination thereof.

At step 114, in some embodiments, the low carbon content of the precursor present in the collection vessel is validated or not validated. In some embodiments, validating the low carbon content of the precursor present in the collection vessel comprises measuring a carbon content of the precursor, so as to validate or not validate the low carbon content of the precursor. In some embodiments, validating the low carbon content of the precursor present in the collection vessel comprises, when the low carbon content is not validated, removing at least a portion of the carbon-containing material from the precursor. In some embodiments, the low carbon content of the precursor present in the collection vessel is measured by Total Carbon analysis using Non-Dispersive Infrared Detection. In some embodiments, the low carbon content of the precursor present in the collection vessel is measured by Total Carbon analysis using Thermal Conductivity Detection.

FIG. 2 is a flowchart of a method 200 for separating a carbon-containing material from a tungsten precursor, according to some embodiments. As shown in FIG. 2, the method 200 for separating a carbon-containing material from a tungsten precursor may comprise at least one of the following steps: a step 202 of applying a first condition to the source vessel, so as to produce a tungsten precursor vapor comprising the carbon-containing material; a step 204 of removing the first portion of the carbon-containing material from the tungsten precursor vapor; a step 206 of flowing the tungsten precursor vapor to a collection vessel; or any combination thereof. In some embodiments, the method 200 relates to separating the tungsten precursor from at least a first portion of the carbon-containing material as described above.

At step 202, in some embodiments, the first condition is applied to the source vessel, so as to produce the tungsten precursor vapor comprising the carbon-containing material. In some embodiments, the first condition includes a first temperature of the source vessel. In some embodiments, the first temperature of the source vessel is a temperature in a range of 60° C. to 170° C., or any range or subrange between 60° C. to 170° C. In some embodiments, the first temperature of source vessel is a temperature in a range of 60° C. to 160° C., 60° C. to 150° C., 60° C. to 140° C., 60° C. to 130° C., 60° C. to 120° C., 60° C. to 110° C., 60° C. to 100° C., 60° C. to 90° C., 60° C. to 80° C., 60° C. to 70° C., 70° C. to 170° C., 80° C. to 170° C., 90° C. to 170° C., 100° C. to 170° C., 110° C. to 170° C., 120° C. to 170° C., 130° C. to 170° C., 140° C. to 170° C., 150° C. to 170° C., 160° C. to 170° C., 100° C. to 160° C., 120° C. to 160° C., 140° C. to 160° C., 120° C. to 150° C., 120° C. to 140° C., or 110° C. to 150° C.

In some embodiments, the first condition includes a first pressure of the source vessel. In some embodiments, the first pressure of the source vessel is a pressure in a range of 0.01 Torr to 100 Torr, or any range or subrange therebetween. In some embodiments, the first pressure of the source vessel is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr.

In some embodiments, the first condition is a condition under which a total pressure of the source vessel is below a true vapor pressure of the tungsten precursor for a given first temperature. In some embodiments, the first condition is a condition under which a total pressure of the source vessel is below a true vapor pressure of the carbon-containing material for a given first temperature. In some embodiments, the tungsten precursor vapor comprises the carbon-containing material. In some embodiments, the carbon-containing material comprises a first carbon-containing vapor. In some embodiments, the carbon-containing material comprises a first plurality of carbon-containing particles. In some embodiments, the carbon-containing material comprises at least one of a first carbon-containing vapor, a first plurality of carbon-containing particles, or any combination thereof.

At step 204, in some embodiments, the first portion of the carbon-containing material is removed from the tungsten precursor vapor. In some embodiments, the step of removing the first portion of the carbon-containing material from the tungsten precursor vapor comprises flowing the tungsten precursor vapor through a filter, so as to remove at least a portion of the first plurality of carbon-containing particles. In some embodiments, the step of removing the first portion of the carbon-containing material from the tungsten precursor vapor comprises flowing the tungsten precursor vapor over a sorbent, so as to remove at least a portion of the first carbon-containing vapor. In some embodiments, the step of removing the first portion of the carbon-containing material from the tungsten precursor vapor comprises flowing the tungsten precursor vapor through a filter, so as to remove at least a portion of the first plurality of carbon-containing particles; and flowing the tungsten precursor vapor over a sorbent, so as to remove at least a portion of the first carbon-containing vapor.

At step 206, the tungsten precursor vapor is flowed to the collection vessel. In some embodiments, the tungsten precursor vapor comprises the carbon-containing material. In some embodiments, the tungsten precursor vapor comprises less of the carbon-containing material than the tungsten precursor vapor prior to the removing step 204.

FIG. 3 is a flowchart of a method 300 for separating a carbon-containing material from a tungsten precursor, according to some embodiments. As shown in FIG. 3, the method 300 for separating a carbon-containing material from a tungsten precursor may comprise at least one of the following steps: a step 302 of applying a second condition to the collection vessel, so as to produce a tungsten precursor condensate and a second carbon-containing vapor; a step 304 of removing at least a portion of the second carbon-containing vapor from the collection vessel; or any combination thereof. In some embodiments, the method 300 relates to separating the tungsten precursor from at least a second portion of the carbon-containing material as described above.

At step 302, in some embodiments, the second condition is applied to the collection vessel so as to produce the tungsten precursor condensate and the second carbon-containing vapor. In some embodiments, producing the tungsten precursor condensate and the second carbon-containing vapor results in separating the tungsten precursor from the second portion of the carbon-containing vapor. In some embodiments, the second condition includes a second temperature of the collection vessel. In some embodiments, the second temperature of the collection vessel is a temperature in a range of 10° C. to 100° C., or any range or subrange therebetween. In some embodiments, the second temperature of the collection vessel is a temperature in a range of 20° C. to 100° C., 30° C. to 100° C., 40° C. to 100° C., 50° C. to 100° C., 60° C. to 100° C., 70° C. to 100° C., 80° C. to 100° C., 90° C. to 100° C., 10° C. to 90° C., 10° C. to 80° C., 10° C. to 70° C., 10° C. to 60° C., 10° C. to 50° C., 10° C. to 40° C., 10° C. to 30° C., or 10° C. to 20° C. In some embodiments, the second temperature of the collection vessel is a temperature sufficient to cause the tungsten precursor vapor to condense. In some embodiments, the second temperature of the collection vessel is a temperature sufficient to result in the second carbon-containing vapor.

In some embodiments, the second condition includes a second pressure of the collection vessel. In some embodiments, the second pressure of the collection vessel is a pressure in a range of 0.01 Torr to 100 Torr, or any range or subrange therebetween. In some embodiments, the second pressure of the collection vessel is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr. In some embodiments, the second pressure of the collection vessel is a pressure sufficient to cause the tungsten precursor vapor to condense. In some embodiments, the second pressure of the collection vessel is a pressure sufficient to result in the second carbon-containing vapor.

In some embodiments, the second condition is applied to the collection vessel, so as to produce the tungsten precursor condensate and the second carbon-containing vapor. In some embodiments, the second condition is a condition under which a greater volume of the tungsten precursor condenses than the second carbon-containing vapor. In some embodiments, the tungsten precursor condensate comprises a greater amount (e.g., mole fraction, volume, or mass fraction) of the tungsten precursor condensate than carbon-containing condensate (if any). In some embodiments, the second condition is a condition under which a greater volume of the second carbon-containing vapor remains vaporized than the tungsten precursor. In some embodiments, the second condition is a condition under which the second carbon-containing vapor comprises the carbon-containing material which was present in the tungsten precursor vapor that was vaporized in the source vessel.

At step 304, in some embodiments, at least a portion of the second carbon-containing vapor is removed from the collection vessel. The second carbon-containing vapor may be removed via an outlet of the collection vessel. The outlet may be fluidly coupled to a gas discharge line, a vacuum line, or other similar line suitable for removing the second carbon-containing vapor from the collection vessel.

FIG. 4 is a flowchart of a method 400 for separating a carbon-containing material from a tungsten precursor, according to some embodiments. As shown in FIG. 4, the method 400 for separating a carbon-containing material from a tungsten precursor may comprise at least one of the following steps: a step 402 of applying a third condition to the source vessel, so as to produce a third carbon-containing vapor; a step 404 of removing at least a portion of the third carbon-containing vapor from the source vessel; or any combination thereof. In some embodiments, the method 400 is performed prior to the step 104 (e.g., FIG. 2). In some embodiments, the method 400 relates to separating the tungsten precursor from at least a third portion of the carbon-containing material as described above.

At step 402, in some embodiments, the third condition is applied to the source vessel, so as to produce the third carbon-containing vapor. In some embodiments, the third condition includes a third temperature of the source vessel. In some embodiments, the third temperature of the source vessel is a temperature in a range of 60° C. to 170° C., or any range or subrange between 60° C. to 170° C. In some embodiments, the third temperature of source vessel is a temperature in a range of 60° C. to 160° C., 60° C. to 150° C., 60° C. to 140° C., 60° C. to 130° C., 60° C. to 120° C., 60° C. to 110° C., 60° C. to 100° C., 60° C. to 90° C., 60° C. to 80° C., 60° C. to 70° C., 70° C. to 170° C., 80° C. to 170° C., 90° C. to 170° C., 100° C. to 170° C., 110° C. to 170° C., 120° C. to 170° C., 130° C. to 170° C., 140° C. to 170° C., 150° C. to 170° C., 160° C. to 170° C., 100° C. to 160° C., 120° C. to 160° C., 140° C. to 160° C., 120° C. to 150° C., 120° C. to 140° C., or 110° C. to 150° C.

In some embodiments, the third condition includes a third pressure of the source vessel. In some embodiments, the third pressure of the source vessel is a pressure in a range of 0.01 Torr to 100 Torr, or any range or subrange therebetween. In some embodiments, the third pressure of the source vessel is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr.

In some embodiments, the third condition is a condition under which a total pressure of the source vessel is below a true vapor pressure of the carbon-containing material for a given third temperature. In some embodiments, the third condition is a condition under which a total pressure of the source vessel is above a true vapor pressure of the tungsten precursor for a given third temperature. In some embodiments, the first condition is a condition such that the carbon-containing material vaporizes, while minimizing the amount of the tungsten precursor that is vaporized. In some embodiments, the third condition is a condition such that the tungsten precursor is not vaporized. In some embodiments, when applying the third condition, the third carbon-containing vapor comprises a greater volume of the carbon-containing material than the tungsten precursor.

The third carbon-containing vapor may comprise a greater volume of the carbon-containing material than the tungsten precursor. In some embodiments, the third carbon-containing vapor comprises less than 10%, less than 9%, less than 8%, less than 7%, less than 6%, less than 5%, less than 4%, less than 3%, less than 2%, less than 1%, less than 0.1%, less than 0.01% by volume of the tungsten precursor based on a total volume of the third carbon-containing vapor. In some embodiments, the third carbon-containing vapor comprises 0.01% to 10%, 0.01% to 9%, 0.01% to 8%, 0.01% to 7%, 0.01% to 6%, 0.01% to 5%, 0.01% to 4%, 0.01% to 3%, 0.01% to 2%, 0.01% to 1%, 0.01% to 0.1%, 0.1% to 10%, 1% to 10%, 2% to 10%, 3% to 10%, 4% to 10%, 5% to 10%, 6% to 10%, 7% to 10%, 8% to 10%, or 9% to 10% by volume of the tungsten precursor based on the total volume of the third carbon-containing vapor.

At step 404, in some embodiments, at least a portion of the third carbon-containing vapor is removed from the source vessel. The third carbon-containing vapor may be removed via an outlet of the source vessel. The outlet may be fluidly coupled to a gas discharge line, a vacuum line, or other similar line suitable for removing the third carbon-containing vapor from the source vessel.

In some embodiments, the method 500 relates to separating the tungsten precursor from at least a fourth portion of the carbon-containing material as described above.

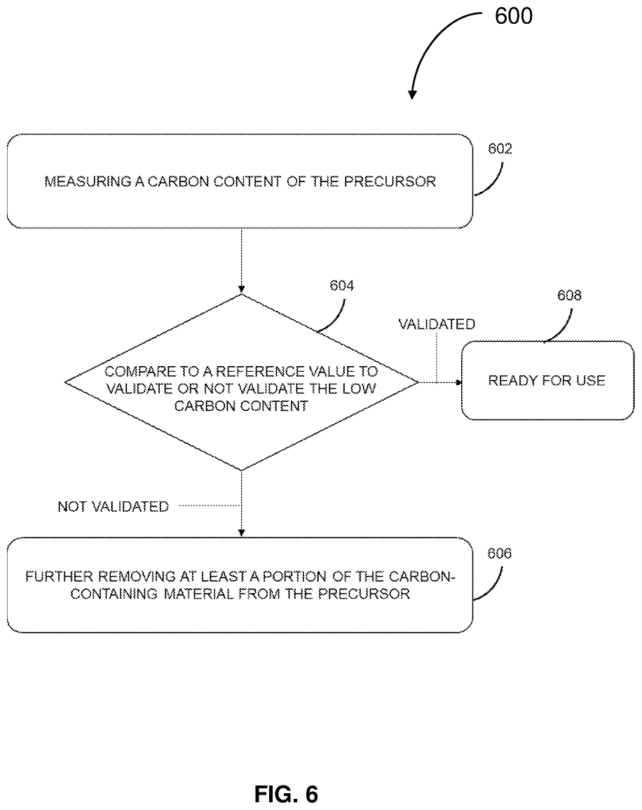

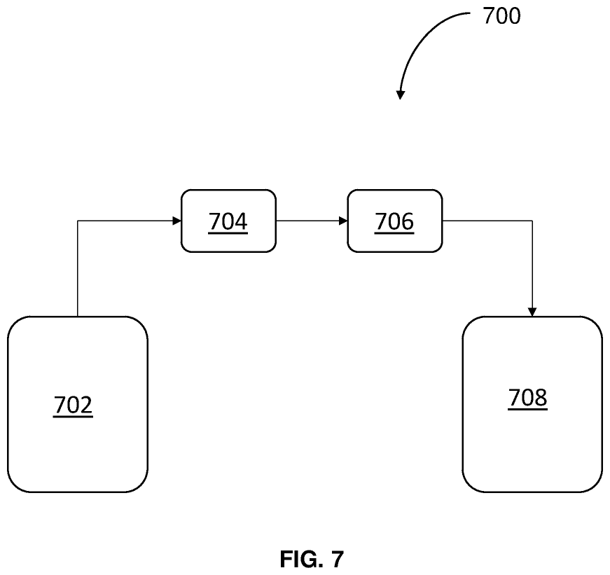

FIG. 5 is a flowchart of a method 500 for separating a carbon-containing material from a tungsten precursor, according to some embodiments. As shown in FIG. 5, the method 500 for separating a carbon-containing material from a tungsten precursor may comprise at least one of the following steps: a step 502 of applying a fourth condition to the collection vessel, so as to produce a fourth carbon-containing vapor; a step 504 of removing at least a portion of the fourth carbon-containing vapor from the collection vessel; or any combination thereof. In some embodiments, the method 500 is performed after the step 112 (e.g., FIG. 6). In some embodiments, the method 500 is performed after the step 114 (e.g., FIG. 7).

In some embodiments, the method 500 relates to separating the tungsten precursor from at least a fourth portion of the carbon-containing material as described above.

At step 502, in some embodiments, the fourth condition is applied to the collection vessel, so as to produce the fourth carbon-containing vapor. In some embodiments, the fourth condition includes a fourth temperature of the collection vessel. In some embodiments, the fourth temperature of the collection vessel is a temperature in a range of 60° C. to 170° C., or any range or subrange between 60° C. to 170° C. In some embodiments, the fourth temperature of collection vessel is a temperature in a range of 60° C. to 160° C., 60° C. to 150° C., 60° C. to 140° C., 60° C. to 130° C., 60° C. to 120° C., 60° C. to 110° C., 60° C. to 100° C., 60° C. to 90° C., 60° C. to 80° C., 60° C. to 70° C., 70° C. to 170° C., 80° C. to 170° C., 90° C. to 170° C., 100° C. to 170° C., 110° C. to 170° C., 120° C. to 170° C., 130° C. to 170° C., 140° C. to 170° C., 150° C. to 170° C., 160° C. to 170° C., 100° C. to 160° C., 120° C. to 160° C., 140° C. to 160° C., 120° C. to 150° C., 120° C. to 140° C., or 110° C. to 150° C.

In some embodiments, the fourth condition includes a fourth pressure of the collection vessel. In some embodiments, the fourth pressure of the collection vessel is a pressure in a range of 0.01 Torr to 100 Torr, or any range or subrange therebetween. In some embodiments, the fourth pressure of the collection vessel is a pressure in a range of 0.01 Torr to 95 Torr, 0.01 Torr to 90 Torr, 0.01 Torr to 85 Torr, 0.01 Torr to 80 Torr, 0.01 Torr to 75 Torr, 0.01 Torr to 70 Torr, 0.01 Torr to 65 Torr, 0.01 Torr to 60 Torr, 0.01 Torr to 55 Torr, 0.01 Torr to 50 Torr, 0.01 Torr to 45 Torr, 0.01 Torr to 40 Torr, 0.01 Torr to 35 Torr, 0.01 Torr to 30 Torr, 0.01 Torr to 25 Torr, 0.01 Torr to 20 Torr, 0.01 Torr to 15 Torr, 0.01 Torr to 10 Torr, 0.01 Torr to 5 Torr, 0.01 Torr to 1 Torr, 0.01 Torr to 0.1 Torr, 0.1 Torr to 100 Torr, 1 Torr to 100 Torr, 5 Torr to 100 Torr, 10 Torr to 100 Torr, 15 Torr to 100 Torr, 20 Torr to 100 Torr, 25 Torr to 100 Torr, 30 Torr to 100 Torr, 35 Torr to 100 Torr, 40 Torr to 100 Torr, 45 Torr to 100 Torr, 50 Torr to 100 Torr, 55 Torr to 100 Torr, 60 Torr to 100 Torr, 65 Torr to 100 Torr, 70 Torr to 100 Torr, 75 Torr to 100 Torr, 80 Torr to 100 Torr, 85 Torr to 100 Torr, 90 Torr to 100 Torr, or 95 Torr to 100 Torr.

In some embodiments, the fourth condition is a condition under which a total pressure of the collection vessel is below a true vapor pressure of the carbon-containing material for a given fourth temperature. In some embodiments, the fourth condition is a condition under which a total pressure of the collection vessel is above a true vapor pressure of the tungsten precursor for a given fourth temperature. In some embodiments, the first condition is a condition such that the carbon-containing material vaporizes, while minimizing the amount of the tungsten precursor that is vaporized. In some embodiments, the fourth condition is a condition such that the tungsten precursor is not vaporized. In some embodiments, when applying the fourth condition, the fourth carbon-containing vapor comprises a greater volume of the carbon-containing material than the tungsten precursor.

The fourth carbon-containing vapor may comprise a greater volume of the carbon-containing material than the tungsten precursor. In some embodiments, the fourth carbon-containing vapor comprises less than 10%, less than 9%, less than 8%, less than 7%, less than 6%, less than 5%, less than 4%, less than 3%, less than 2%, less than 1%, less than 0.1%, less than 0.01% by volume of the tungsten precursor based on a total volume of the fourth carbon-containing vapor. In some embodiments, the fourth carbon-containing vapor comprises 0.01% to 10%, 0.01% to 9%, 0.01% to 8%, 0.01% to 7%, 0.01% to 6%, 0.01% to 5%, 0.01% to 4%, 0.01% to 3%, 0.01% to 2%, 0.01% to 1%, 0.01% to 0.1%, 0.1% to 10%, 1% to 10%, 2% to 10%, 3% to 10%, 4% to 10%, 5% to 10%, 6% to 10%, 7% to 10%, 8% to 10%, or 9% to 10% by volume of the tungsten precursor based on the total volume of the fourth carbon-containing vapor.

At step 504, in some embodiments, at least a portion of the fourth carbon-containing vapor is removed from the collection vessel. The fourth carbon-containing vapor may be removed via an outlet of the collection vessel. The outlet may be fluidly coupled to a gas discharge line, a vacuum line, or other similar line suitable for removing the fourth carbon-containing vapor from the collection vessel.

FIG. 6 is a flowchart of a method 600 for validating a low impurity content of a tungsten precursor, according to some embodiments. As shown in FIG. 6, in some embodiments, the method 600 for validating a low impurity content of a tungsten precursor may comprise at least one of the following steps: a step 602 of measuring a carbon content of the precursor, so as to validate or not validate the low carbon content of the precursor; a step 604 of comparing the measured carbon content to a reference value to validate or not validate the low carbon content of the precursor. If the low carbon content of the precursor is validated, the precursor is ready for use 608. If the low carbon content of the precursor is not validated, the method 600 comprises further removing 606 at least a portion of the carbon-containing material from the precursor. In some embodiments, the method 600 comprises measuring a carbon content of the precursor comprises applying a temperature (e.g., 800° C. to 2500° C., or any range or subrange therebetween) to the collection vessel, removing a sample from the collection vessel (e.g., removing a solid sample from the collection vessel (e.g., 0.01 g to 1.50 g), removing a vapor sample in a headspace above any unvaporized precursor, or any combination thereof), and analyzing the vapor sample by at least one of Total Carbon analysis using Non-Dispersive Infrared Detection, Total Carbon analysis using Thermal Conductivity Detection, gas chromatography, or any combination thereof. In some embodiments, removing at least a portion of the carbon-containing material from the precursor involves repeating one or more of the step 104 (e.g., including, without limitation, at least one of the steps of FIG. 2), the step 106 (e.g., including, without limitation, at least one of the steps of FIG. 3), the step 108 (e.g., including, without limitation, at least one of the steps of FIG. 4), the step 110 (e.g., including, without limitation, at least one of the steps of FIG. 5), or any combination thereof. In some embodiments, the method 600 relates to a method for validating the low carbon content of the tungsten precursor as described above.

FIG. 7 is a schematic diagram of a system 700 for removing a carbon-containing material from a precursor, according to some embodiments. As shown in FIG. 7, in some embodiments, the system 700 comprises a first vessel 702, a second vessel 708, a first removal unit 704, and a second removal unit 706. The first vessel 702 may be fluidly coupled to the second vessel 708. In some embodiments, the first removal unit 704 comprises a filter for removing a carbon-containing material from a vapor. In some embodiments, the carbon-containing material which is removed by the filter is a plurality of carbon-containing particles. In some embodiments, the second removal unit 706 comprises a sorbent for removing a carbon-containing material from a vapor. In some embodiments, the carbon-containing material which is removed by the sorbent is a carbon-containing vapor. Although the second removal unit 706 is depicted downstream of the first removal unit 704, it will be appreciated that other configurations are possible, including, for example and without limitation, the second removal unit 706 being located upstream of the first removal unit 704. In addition, additional removal units (e.g., 704, 706) may be added or removed from the system without departing from the scope of this disclosure.

### Example 1

125 mg of a WCl₅ precursor was added to a tin capsule inside of an air-and-moisture free glovebox. The mass of the WCl₅ precursor was measured using an analytical balance and recorded. The tin capsule containing the WCl₅ precursor was hermetically sealed inside of the glovebox. Total Carbon value was measured to be on average 126 ppm as determined using a Total Carbon analyzer using NDIR detection.

### Example 2

0.01 g of a WCl₅ precursor is added to a tin capsule inside of an air-and-moisture free glovebox. The mass of the WCl₅ precursor is measured using an analytical balance and recorded. The tin capsule containing the WCl₅ precursor is hermetically sealed inside of the glovebox. Total Carbon value is measured using a Total Carbon analyzer using NDIR detection.

### Example 3

1.5 g of a WCl₅ precursor is added to a tin capsule inside of an air-and-moisture free glovebox. The mass of the WCl₅ precursor is measured using an analytical balance and recorded. The tin capsule containing the WCl₅ precursor is hermetically sealed inside of the glovebox. Total Carbon value is measured using a Total Carbon analyzer using NDIR detection.

### Example 4

125 mg of a WCl₆ precursor is added to a tin capsule inside of an air-and-moisture free glovebox. The mass of the WCl₆ precursor is measured using an analytical balance and recorded. The tin capsule containing the WCl₆ precursor is hermetically sealed inside of the glovebox. Total Carbon value is measured to be on average 126 ppm as determined using a Total Carbon analyzer using NDIR detection.

### Example 5

0.01 g of a WCl₆ precursor is added to a tin capsule inside of an air-and-moisture free glovebox. The mass of the WCl₆ precursor is measured using an analytical balance and recorded. The tin capsule containing the WCl₆ precursor is hermetically sealed inside of the glovebox. Total Carbon value is measured using a Total Carbon analyzer using NDIR detection.

### Example 6

1.5 g of a WCl₆ precursor is added to a tin capsule inside of an air-and-moisture free glovebox. The mass of the WCl₆ precursor is measured using an analytical balance and recorded. The tin capsule containing the WCl₆ precursor is hermetically sealed inside of the glovebox. Total Carbon value is measured using a Total Carbon analyzer using NDIR detection.

### Aspects

Various Aspects are described below. It is to be understood that any one or more of the features recited in the following Aspect(s) can be combined with any one or more other Aspect(s).
Aspect 1. A precursor comprising:
   a tungsten precursor; and
   a carbon-containing material,
      wherein the precursor comprises less than 0.015% by weight of the carbon-containing material based on a total weight of the precursor, as measured by Total Carbon analysis using Non-Dispersive Infrared Detection.
Aspect 2. The precursor according to Aspect 1, wherein the precursor comprises less than 0.005% by weight of the carbon-containing material based on the total weight of the precursor, as measured by Total Carbon analysis using Non-Dispersive Infrared Detection.
Aspect 3. The precursor according to any one of Aspects 1-2, wherein the precursor comprises less than 0.001% by weight of the carbon-containing material based on the total weight of precursor, as measured by Total Carbon analysis using Non-Dispersive Infrared Detection.
Aspect 4. The precursor according to any one of Aspects 1-3, wherein the precursor comprises less than 0.0002% by weight of the carbon-containing material based on the total weight of precursor, as measured by Total Carbon analysis using Non-Dispersive Infrared Detection.
Aspect 5. The precursor according to any one of Aspects 1-4, wherein the precursor comprises 0.0002% to 0.001% by weight of the carbon-containing material based on the total weight of precursor, as measured by Total Carbon analysis using Non-Dispersive Infrared Detection.
Aspect 6. The precursor according to any one of Aspects 1-5, wherein the carbon-containing material comprises a chlorinated hydrocarbon.
Aspect 7. The precursor according to any one of Aspects 1-6, wherein the carbon-containing material comprises at least one of dichloromethane, phosgene, 1,1-dichloroethane, chloroform, 1,2-dichloroethane, carbon tetrachloride, tetrachloroethylene, trichlorethylene, 1,3-dichloropropane, 1,2,3-trichloropropane, 1,2-dichloropropane, 1,1,2-trichloroethane, 1,1,2-trichloropropane, 1,2,2-trichloropropane, 1,1,2,3-tetrachloropropane, 1,2,2,3-tetrachloropropane, 1,1,2,2,-tetrachloroethane, 2,2-dichloropropanoyl chloride, 1,3-dichloro-1-propene, 3,3,3-trichloro-1-propene, 1,2,3-trichloro-1-propene, 1,3-dichloro-2-methylenepropane, 1,4-dichlorobutane, 1,3-dichloro-2-butene, 1,1,3,3-tetrachloro-2-methylpropane, 1,1,2,3,3-pentachloropropane, 1,3-dichlorocyclopentane, 1,1,2,2,3,3-hexachloropropane, 1,2,3,4,5,5-hexanechloro-1,3-cyclopentadiene, trichlorocyclopentene, tetrachlorocyclopentene, pentachloronorbornene, or any combination thereof.
Aspect 8. A method comprising:
   a) obtaining a source vessel containing a tungsten precursor and a carbon-containing material;
   b) separating the tungsten precursor from at least a first portion of the carbon-containing material, wherein the separating comprises:
      applying a first condition to the source vessel, so as to produce a tungsten precursor vapor comprising the carbon-containing material,
         wherein the carbon-containing material comprises at least one of a first carbon-containing vapor, a first plurality of carbon-containing particles, or any combination thereof;
      removing the first portion of the carbon-containing material from the tungsten precursor vapor;
      flowing the tungsten precursor vapor to a collection vessel;
   c) recovering a precursor in a collection vessel.
Aspect 9. The method according to Aspect 8, wherein the step of removing the first portion of the carbon-containing material from the tungsten precursor vapor comprises:
   flowing the tungsten precursor vapor through a filter, so as to remove at least a portion of the first plurality of carbon-containing particles.
Aspect 10. The method according to any one of Aspects 8-9, wherein the step of removing the first portion of the carbon-containing material from the tungsten precursor vapor comprises:
   flowing the tungsten precursor vapor over a sorbent, so as to remove at least a portion of the first carbon-containing vapor.
Aspect 11. The method according to any one of Aspects 8-10, wherein the step of removing the first portion of the carbon-containing material from the tungsten precursor vapor comprises:
   flowing the tungsten precursor vapor through a filter, so as to remove at least a portion of the first plurality of carbon-containing particles;
   flowing the tungsten precursor vapor over a sorbent, so as to remove at least a portion of the first carbon-containing vapor.
Aspect 12. The method according to any one of Aspects 8-11, wherein the first condition is a condition under which a total pressure of the source vessel is below a true vapor pressure of the tungsten precursor for a given first temperature.
Aspect 13. The method according to any one of Aspects 8-12, wherein the first condition is a condition under which a total pressure of the source vessel is below a true vapor pressure of the carbon-containing material for a given first temperature.
Aspect 14. The method according to anyone of Aspects 8-13, further comprising:
   d) separating the tungsten precursor from at least a second portion of the carbon-containing material, wherein the separating step d) comprises:
      applying a second condition to the collection vessel, so as to produce a tungsten precursor condensate and a second carbon-containing vapor;
      removing at least a portion of the second carbon-containing vapor from the collection vessel.
Aspect 15. The method according to Aspect 14, wherein the second condition is a condition under which a greater volume of the tungsten precursor condenses than the second carbon-containing vapor.
Aspect 16. The method according to Aspect 14, wherein, when applying the second condition, the tungsten precursor condensate comprises a greater mole fraction of the tungsten precursor than the carbon-containing material.
Aspect 17. The method according to any one of Aspects 8-16, further comprising:
   e) separating the tungsten precursor from a third portion of the carbon-containing material, wherein the separating step e) comprises:
      applying a third condition to the source vessel, so as to produce a third carbon-containing vapor; and
      removing at least a portion of the third carbon-containing vapor from the source vessel;
      wherein the separating step e) is performed prior to the separating step b).
Aspect 18. The method according to Aspect 17, wherein the third condition is a condition under which a total pressure of the source vessel is below a true vapor pressure of the carbon-containing material for a given third temperature.
Aspect 19. The method according to Aspect 17, wherein the third condition is a condition under which a total pressure of the source vessel is above a true vapor pressure of the tungsten precursor for a given third temperature.
Aspect 20. The method according to Aspect 17, wherein, when applying the third condition, the third carbon-containing vapor comprises a greater volume of the carbon-containing material than the tungsten precursor.
Aspect 21. The method according to any one of Aspects 8-20, further comprising:
   f) validating a low carbon content of the precursor present in the collection vessel, wherein the validating step f) comprises:
      measuring a carbon content of the precursor, so as to validate or not validate the low carbon content of the precursor;
      when the low carbon content is not validated, removing at least a portion of the carbon-containing material from the precursor.
Aspect 22. The method according to Aspect 21, wherein the low carbon content of the precursor present in the collection vessel is measured by Total Carbon analysis using Non-Dispersive Infrared Detection.
Aspect 23. The method according to Aspect 21, wherein the low carbon content of the precursor present in the collection vessel is measured by Total Carbon analysis using Thermal Conductivity Detection.
Aspect 24. The method according to any one of Aspects 8-23, further comprising:
   g) separating the tungsten precursor from a fourth portion of the carbon-containing material, wherein the separating step g) comprises:
      applying a fourth condition to the collection vessel, so as to produce a fourth carbon-containing vapor; and
      removing at least a portion of the fourth carbon-containing vapor from the collection vessel.
Aspect 25. The method according to Aspect 24, wherein the fourth condition is a condition under which a total pressure of the collection vessel is below a true vapor pressure of the carbon-containing material for a given fourth temperature.
Aspect 26. The method according to Aspect 24, wherein the fourth condition is a condition under which a total pressure of the collection vessel is above a true vapor pressure of the tungsten precursor for a given fourth temperature.
Aspect 27. The method according to Aspect 24, wherein, when applying the fourth condition, the fourth carbon-containing vapor comprises a greater volume of the carbon-containing material than the tungsten precursor.
It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.
Aspect 28. The method according to any of Aspects 8-27, wherein the precursor recovered in the collection vessel wherein the precursor comprises less than 0.02% by weight of the carbon-containing material based on a total weight of the precursor, as measured by Total Carbon analysis using Non-Dispersive Infrared Detection.

What is claimed is:

1. A precursor comprising:
tungsten precursor; and
a carbon-containing material,
wherein the precursor comprises less than 0.02% by weight of the carbon-containing material based on a total weight of the precursor, as measured by Total Carbon analysis using Non-Dispersive Infrared Detection.

2. The precursor of claim 1, wherein the precursor comprises less than 0.015% by weight of the carbon-containing material based on the total weight of the precursor, as measured by Total Carbon analysis using Non-Dispersive Infrared Detection.

3. The precursor of claim 1, wherein the precursor comprises less than 0.001% by weight of the carbon-containing material based on the total weight of precursor, as measured by Total Carbon analysis using Non-Dispersive Infrared Detection.

4. The precursor of claim 1, wherein the precursor comprises less than 0.0002% by weight of the carbon-containing material based on the total weight of precursor, as measured by Total Carbon analysis using Non-Dispersive Infrared Detection.

5. The precursor of claim 1, wherein the precursor comprises 0.0002% to 0.001% by weight of the carbon-containing material based on the total weight of precursor, as measured by Total Carbon analysis using Non-Dispersive Infrared Detection.

6. The precursor of claim 1, wherein the carbon-containing material comprises a chlorinated hydrocarbon.

7. The precursor of claim 1, wherein the carbon-containing material comprises a volatile compound, a non-volatile compound, or any combination thereof.

8. The precursor of claim 1, wherein the carbon-containing material comprises at least one of hydrocarbon polymers (optionally substituted), haloalkanes, haloalkenes, halocycloalkyl, halo-substituted arenes, or any combination thereof.

9. The precursor of claim 1, wherein the carbon-containing material comprises at least one of dichloromethane, phosgene, 1,1-dichloroethane, chloroform, 1,2-dichloroethane, carbon tetrachloride, tetrachloroethylene, trichlorethylene, 1,3-dichloropropane, 1,2,3-trichloropropane, 1,2-dichloropropane, 1,1,2-trichloroethane, 1,1,2-trichloropropane, 1,2,2-trichloropropane, 1,1,2,3-tetrachloropropane, 1,2,2,3-tetrachloropropane, 1,1,2,2,-tetrachloroethane, 2,2-dichloropropanoyl chloride, 1,3-dichloro-1-propene, 3,3,3-trichloro-1-propene, 1,2,3-trichloro-1-propene, 1,3-dichloro-2-methylenepropane, 1,4-dichlorobutane, 1,3-dichloro-2-butene, 1,1,3,3-tetrachloro-2-methylpropane, 1,1,2,3,3-pentachloropropane, 1,3-dichlorocyclopentane, 1,1,2,2,3,3-hexachloropropane, 1,2,3,4,5,5-hexanechloro-1,3-cyclopentadiene, trichlorocyclopentene, tetrachlorocyclopentene, pentachloronorbornene, or any combination thereof.

10. A method comprising:
a) obtaining a source vessel containing a tungsten precursor and a carbon-containing material;
b) separating the tungsten precursor from at least a first portion of the carbon-containing material, wherein the separating comprises:
applying a first condition to the source vessel, so as to produce a tungsten precursor vapor comprising the carbon-containing material,
wherein the carbon-containing material comprises at least one of a first carbon-containing vapor, a first plurality of carbon-containing particles, or any combination thereof;
removing the first portion of the carbon-containing material from the tungsten precursor vapor;
flowing the tungsten precursor vapor to a collection vessel;
c) recovering a precursor in a collection vessel.

11. The method of claim 10, wherein the step of removing the first portion of the carbon-containing material from the tungsten precursor vapor comprises:
flowing the tungsten precursor vapor through a filter, so as to remove at least a portion of the first plurality of carbon-containing particles.

12. The method of claim 10, wherein the step of removing the first portion of the carbon-containing material from the tungsten precursor vapor comprises:
flowing the tungsten precursor vapor over a sorbent, so as to remove at least a portion of the first carbon-containing vapor.

13. The method of claim 10, wherein the step of removing the first portion of the carbon-containing material from the tungsten precursor vapor comprises:
flowing the tungsten precursor vapor through a filter, so as to remove at least a portion of the first plurality of carbon-containing particles;
flowing the tungsten precursor vapor over a sorbent, so as to remove at least a portion of the first carbon-containing vapor.

14. The method of claim 10, wherein the first condition is a condition under which a total pressure of the source vessel is below a true vapor pressure of tungsten precursor for a given first temperature.

15. The method of claim 10, wherein the first condition is a condition under which a total pressure of the source vessel is below a true vapor pressure of the carbon-containing material for a given first temperature.

16. The method of claim 10, further comprising:
d) separating the tungsten precursor from at least a second portion of the carbon-containing material, wherein the separating step d) comprises:
applying a second condition to the collection vessel, so as to produce a tungsten precursor condensate and a second carbon-containing vapor;
removing at least a portion of the second carbon-containing vapor from the collection vessel.

17. The method of claim 16, wherein the second condition is a condition under which a greater volume of the tungsten precursor condenses than the second carbon-containing vapor.

18. The method of claim 16, wherein, when applying the second condition, the tungsten precursor condensate comprises a greater mole fraction of the tungsten precursor than the carbon-containing material.

19. The method of claim 10, further comprising:
e) separating the tungsten precursor from a third portion of the carbon-containing material, wherein the separating step e) comprises:
applying a third condition to the source vessel, so as to produce a third carbon-containing vapor; and
removing at least a portion of the third carbon-containing vapor from the source vessel;
wherein the separating step e) is performed prior to the separating step b).

20. The method of claim 19, wherein the third condition is a condition under which a total pressure of the source vessel is below a true vapor pressure of the carbon-containing material for a given third temperature.
